(19) United States
(12) Patent Application Publication
(10) Pub. No.: US 2011/0112676 A1
(43) Pub. Date: May 12, 2011

(54) WORK PROCESS CONTROL DEVICE, WORK PROCESS CONTROL METHOD, AND PROGRAM

(75) Inventor: Hiroaki IZUMI, Tokyo (JP)

(73) Assignee: ELPIDA MEMORY, INC, Tokyo (JP)

(21) Appl. No.: 12/914,157

(22) Filed: Oct. 28, 2010

(30) Foreign Application Priority Data
Nov. 6, 2009 (JP) 2009-254788

(51) Int. Cl. G06F 19/00

(52) U.S. Cl. 700/101; 700/100

(57) ABSTRACT

An apparatus for controlling work process includes a lot allocation unit that gives a highest priority for lot-allocation to a device available for process. The device, which is given the highest priority, has at least one of a minimum number of lots-in-process and a maximum number of unworkable processes among devices available for process.

### BACKGROUND OF THE INVENTION

1. Field of the Invention

The present invention relates to a work process control device, a work process control method, and a program.

Priority is claimed on Japanese Patent Application No. 2009-254788, filed Nov. 6, 2009, the content of which is incorporated herein by reference.

2. Description of the Related Art

In general, a plurality of semiconductor wafers, for example, twenty five wafers, are formed together in one lot. Each lot is sequentially processed according to a preset sequence of manufacturing processes depending on an item to be produced. At present, in semiconductor device manufacturing facilities, not only a plurality of items are simultaneously manufactured in the same production line, but also a manufacturing process set for each item is complex. If a plurality of processing devices correspond to one manufacturing process, significantly complex process management such as disabling operation of a specific device is necessary to improve manufacturing yield. The specific device may include, but is not limited to, a specific work device among the same type of manufacturing devices.

In the fabrication of semiconductor devices, it is important to maximally shorten a turn-around time (TAT) required for processing each lot and to efficiently produce semiconductor devices. To efficiently produce the semiconductor devices, various methods of deciding a sequence of work lots of each manufacturing device have been proposed. These matters are disclosed in Japanese Unexamined Patent Application Publications Nos. 7-200675 and 2005-301653.

### SUMMARY

In one embodiment, an apparatus for controlling work process may include, but is not limited to, the following elements. A priority calculation unit calculates a respective priority for each of devices available for process and for each of lots-in-process, with reference to at least first, second, third and fourth sets of information. The first set of information may include, but is not limited to, a respective number of lots-in-process for each of devices available for processing the lots-in-process. The second set of information may include, but is not limited to, a respective number of devices available for processing each of the lots-in-process. The third set of information may include, but is not limited to, a respective standard work time for each of the devices available for processing the lots-in-process and for each of the lots-in-process. The fourth set of information may include, but is not limited to, a respective maximum possible working rate for each of the devices available for processing the lots-in-process. The allocation decision unit decides a respective one of the devices, to which each of the lots-in-process is to be allocated, with reference to the respective priorities.

In another embodiment, an apparatus for controlling work process may include, but is not limited to, a lot allocation unit that gives a highest priority for lot-allocation to a device available for process. The device, which is given the highest priority, has at least one of a minimum number of lots-in-process and a maximum number of unworkable processes among devices available for process.

In still another embodiment, an apparatus for controlling work process may include, but is not limited to, a lot allocation unit that determines a respective device, to which each of selected lots is to be allocated. The selected lots are lots on which actual working is currently required. The lot allocation unit determines the respective device with reference to at least a number of devices available for processing the selected lots and a number of the selected lots.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram illustrating configurations of a work process control device in accordance with a preferred embodiment of the present invention;

FIG. 2A is a table showing information created by the work process control device of FIG. 1;

FIG. 2B is a table showing information created by the work process control device of FIG. 1;

FIG. 3 is a table showing information created by the work process control device of FIG. 1;

FIG. 4 is a flow chart showing operations performed by the work process control device of FIG. 1;

FIG. 5 is a flow chart showing operations performed by the work process control device of FIG. 1;

FIG. 6A is a table showing a result of allocation performed in accordance with a method 1 as a related art;

FIG. 6B is a table showing a result of allocation performed in accordance with a method 2 as another related art;

FIG. 6C is a table showing a result of allocation performed in accordance with a method performed by the work process control device of FIG. 1;

FIG. 7A is a table showing a result of allocation performed in accordance with a related art;

FIG. 7B is a table showing a result of allocation performed in accordance with a related art;

FIG. 7C is a table showing a result of allocation performed in accordance with a related art;

FIG. 7D is a table showing a result of allocation performed in accordance with a related art;

FIG. 7E is a table showing a result of allocation performed in accordance with a related art;

FIG. 8A is a table showing a result of allocation performed by the work process control device of FIG. 1;

FIG. 8B is a table showing a result of allocation performed by the work process control device of FIG. 1; and

FIG. 8C is a table showing a result of allocation performed by the work process control device of FIG. 1.

### DETAILED DESCRIPTION OF THE PREFERRED EMBODIMENTS

Before describing the present invention, the related art will be explained in detail, in order to facilitate the understanding of the present invention.

The above-described method has a problem in that an optimal device which processes each lot may not be decided. Also, there is a problem in that the decision of a device which processes each lot is time-consuming.

That is, if a work lot is decided systematically, not by empirical rule of a worker, a best possible device can be obtained by a simulation or a search for covering all patterns. However, there is a problem in that an operating ratio of a device is decreased in the method of obtaining the best possible device through simulation. As disclosed in Japanese Unexamined Patent Application Publication No. 7-200675, a given rule in the simulation is a rule of obtaining a device in which the earliest processing is possible. If a combination of devices in which a manufacturing process and work are inhibited is complex, a state in which a device is waiting for work (hereinafter, referred to “empty device state”) may occur even though the number of lots waiting for work is greater than the number of devices.

Since it is necessary to calculate a power of the number of devices and the number of devices of lots in process in a method of obtaining a best possible device by full coverage calculation, there is a problem in that a calculation amount is large. In particular, there is a problem in that a calculation time for an optimal solution is extremely long in a manufacturing line of a large production scale.

Embodiments of the invention will be now described herein with reference to illustrative embodiments. Those skilled in the art will recognize that many alternative embodiments can be accomplished using the teaching of the embodiments of the present invention and that the invention is not limited to the embodiments illustrated for explanatory purpose.

In one embodiment, an apparatus for controlling work process may include, but is not limited to, the following elements. A priority calculation unit calculates a respective priority for each of devices available for process and for each of lots-in-process, with reference to at least first, second, third and fourth sets of information. The first set of information may include, but is not limited to, a respective number of lots-in-process for each of devices available for processing the lots-in-process. The second set of information may include, but is not limited to, a respective number of devices available for processing each of the lots-in-process. The third set of information may include, but is not limited to, a respective standard work time for each of the devices available for processing the lots-in-process and for each of the lots-in-process. The fourth set of information may include, but is not limited to, a respective maximum possible working rate for each of the devices available for processing the lots-in-process. The allocation decision unit decides a respective one of the devices, to which each of the lots-in-process is to be allocated, with reference to the respective priorities.

In some cases, the priority calculation unit calculates the respective priorities based on the respective numbers of lots-in-process, the respective numbers of devices available, the respective standard work times, and the respective maximum possible working rates.

In some cases, the priority calculation unit calculates each of the priorities by multiplying: the reciprocal of the respective number of lots-in-process for each of devices available for processing the lots-in-process; the reciprocal of the respective number of devices available for processing each of the lots-in-process; the reciprocal of the respective standard work time for each of the devices available for processing the lots-in-process and for each of the lots-in-process; and the respective maximum possible working rate for each of the devices available for processing the lots-in-process.

In some cases, the allocation decision unit selects a respective one of the devices for each of the lots-in-process so that the respective one has a maximum priority in the each lot-in-process.

In some cases, the allocation decision unit extracts respective combinations of the lots-in-process and the respective ones of the devices, to which the lots-in-process are to be allocated respectively, and the allocation decision unit selects one-by-one the respective combinations in the order of priority.

In some cases, the apparatus may further include, but is not limited to, a priority calculation information acquisition unit that calculates: the respective number of lots-in-process for each of devices available for processing the lots-in-process, the respective number of devices available for processing each of the lots-in-process, the respective standard work time for each of the devices available for processing the lots-in-process and for each of the lots-in-process, and the respective maximum possible working rate for each of the devices available for processing the lots-in-process.

In some cases, the apparatus may further include, but is not limited to, a priority temporary-allocation unit that executes temporary allocation for priority-processing of a lot-in-process according to a rule. The lot-in-process is a lot that is being in a waiting state. The priority calculation information acquisition unit receives a result of execution of the temporary allocation from the priority temporary-allocation unit.

In some cases, the apparatus may further include, but is not limited to, an empty device determination unit that receives the result of execution of the temporary allocation from the priority temporary-allocation unit. The empty device determination unit manages operating states of the devices. The empty device determination unit determines, whether each of the devices is in working state or in empty state, based on an operating state of each of the devices and on the result of execution of the temporary allocation. The empty device determination unit notifies, to the priority temporary-allocation unit, a result of determination of whether each of the devices is in working state or in empty state.

In another embodiment, an apparatus for controlling work process may include, but is not limited to, a lot allocation unit that gives a highest priority for lot-allocation to a device available for process. The device, which is given the highest priority, has at least one of a minimum number of lots-in-process and a maximum number of unworkable processes among devices available for process.

In some cases, the lot allocation unit may include, but is not limited to, a priority calculation unit that calculates a respective priority for each of devices available for process and for each of lots-in-process, with reference to at least first, second, third and fourth sets of information. The first set of information may include, but is not limited to, a respective number of lots-in-process for each of devices available for processing the lots-in-process. The second set of information may include, but is not limited to, a respective number of devices available for processing each of the lots-in-process. The third set of information may include, but is not limited to, a respective standard work time for each of the devices available for processing the lots-in-process and for each of the lots-in-process. The fourth set of information may include, but is not limited to, a respective maximum possible working rate for each of the devices available for processing the lots-in-process.

In some cases, the priority calculation unit calculates the respective priorities based on the respective numbers of lots-in-process, the respective numbers of devices available, the respective standard work times, and the respective maximum possible working rates.

In some cases, the priority calculation unit calculates each of the priorities by multiplying: the reciprocal of the respective number of lots-in-process for each of devices available for processing the lots-in-process; the reciprocal of the respective number of devices available for processing each of the lots-in-process; the reciprocal of the respective standard work time for each of the devices available for processing the lots-in-process and for each of the lots-in-process; and the respective maximum possible working rate for each of the devices available for processing the lots-in-process.

In some cases, the lot allocation unit may further include, but is not limited to, an allocation decision unit that decides a respective one of the devices, to which each of the lots-in-process is to be allocated, with reference to the respective priorities.

In some cases, the allocation decision unit selects a respective one of the devices for each of the lots-in-process so that the respective one has a maximum priority in the each lot-in-process.

In some cases, the allocation decision unit extracts respective combinations of the lots-in-process and the respective ones of the devices, to which the lots-in-process are to be allocated respectively, and the allocation decision unit selects one-by-one the respective combinations in the order of priority.

In some cases, the apparatus may include, but is not limited to, a priority calculation information acquisition unit that calculates: the respective number of lots-in-process for each of devices available for processing the lots-in-process, the respective number of devices available for processing each of the lots-in-process, the respective standard work time for each of the devices available for processing the lots-in-process and for each of the lots-in-process, and the respective maximum possible working rate for each of the devices available for processing the lots-in-process.

In some cases, the apparatus may further include, but is not limited to, a priority temporary-allocation unit that executes temporary allocation for priority-processing of a lot-in-process according to a rule. The lot-in-process is a lot that is being in a waiting state. The priority calculation information acquisition unit receives a result of execution of the temporary allocation from the priority temporary-allocation unit.

In some cases, the apparatus may further include, but is not limited to, an empty device determination unit that receives the result of execution of the temporary allocation from the priority temporary-allocation unit. The empty device determination unit manages operating states of the devices. The empty device determination unit determines, whether each of the devices is in working state or in empty state, based on an operating state of each of the devices and on the result of execution of the temporary allocation. The empty device determination unit notifies, to the priority temporary-allocation unit, a result of determination of whether each of the devices is in working state or in empty state.

In still another embodiment, an apparatus for controlling work process may include, but is not limited to, a lot allocation unit that determines a respective device, to which each of selected lots is to be allocated. The selected lots are lots on which actual working is currently required. The lot allocation unit determines the respective device with reference to at least a number of devices available for processing the selected lots and a number of the selected lots.

In some cases, the lot allocation unit determines the respective device by multiplying: the reciprocal of a respective number of lots in the selected lots for each of devices available for processing the selected lots; the reciprocal of a respective number of devices available for processing each of the selected lots; the reciprocal of a respective standard work time for each of the devices available for processing the selected lots and for each of the selected lots; and a respective maximum possible working rate for each of the devices available for processing the selected lots.

### Preferred Embodiments

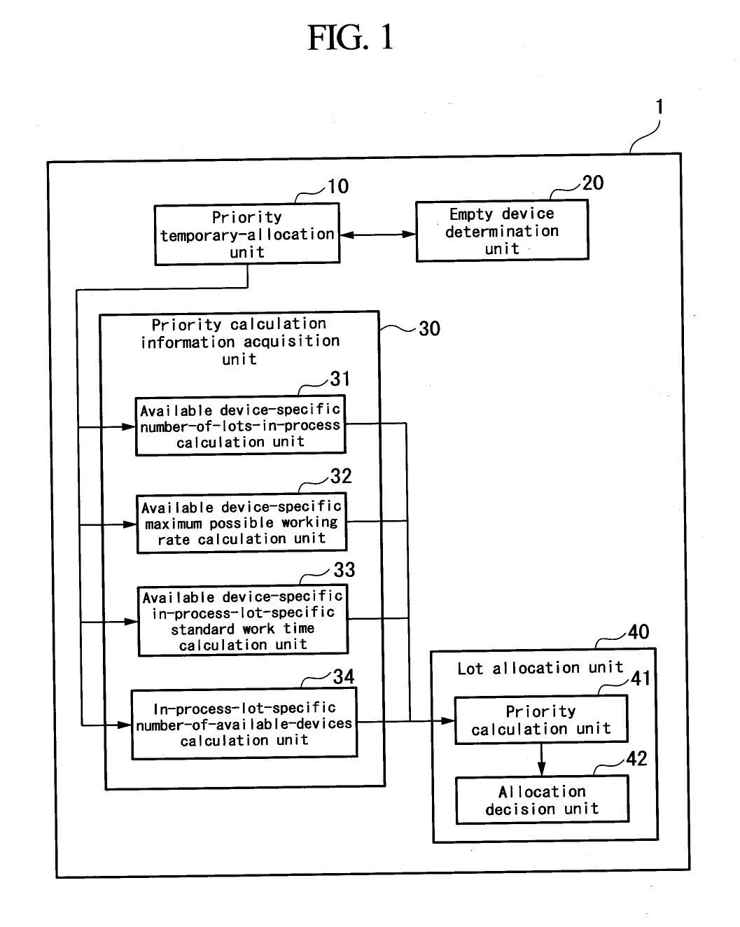

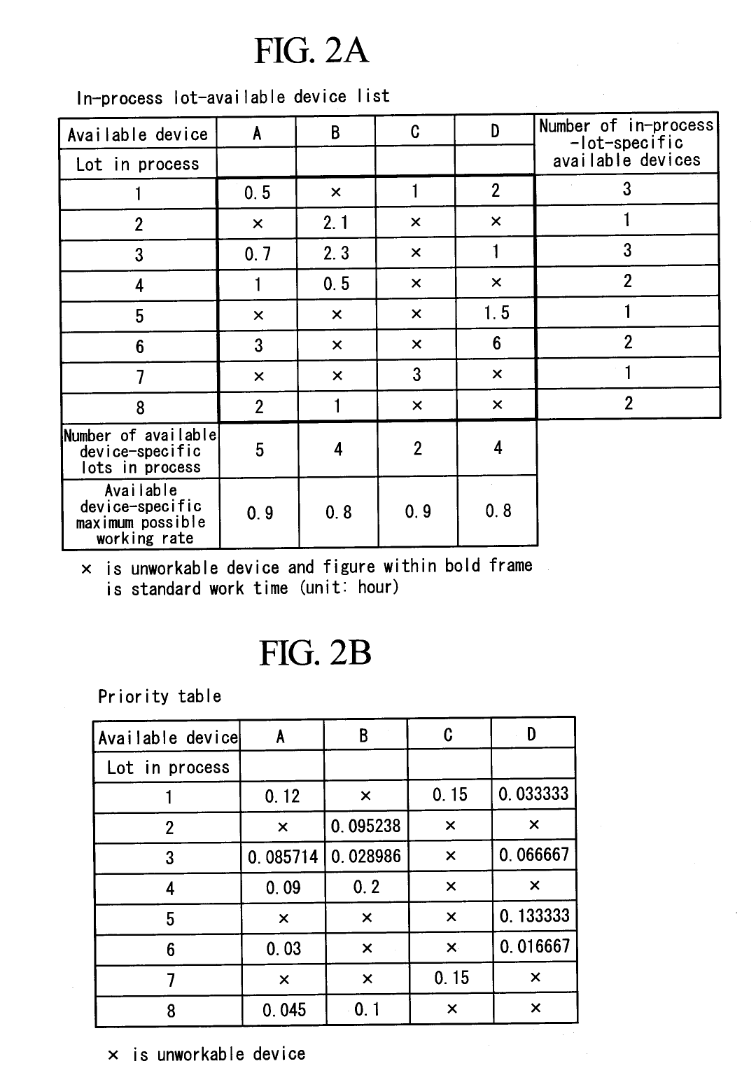

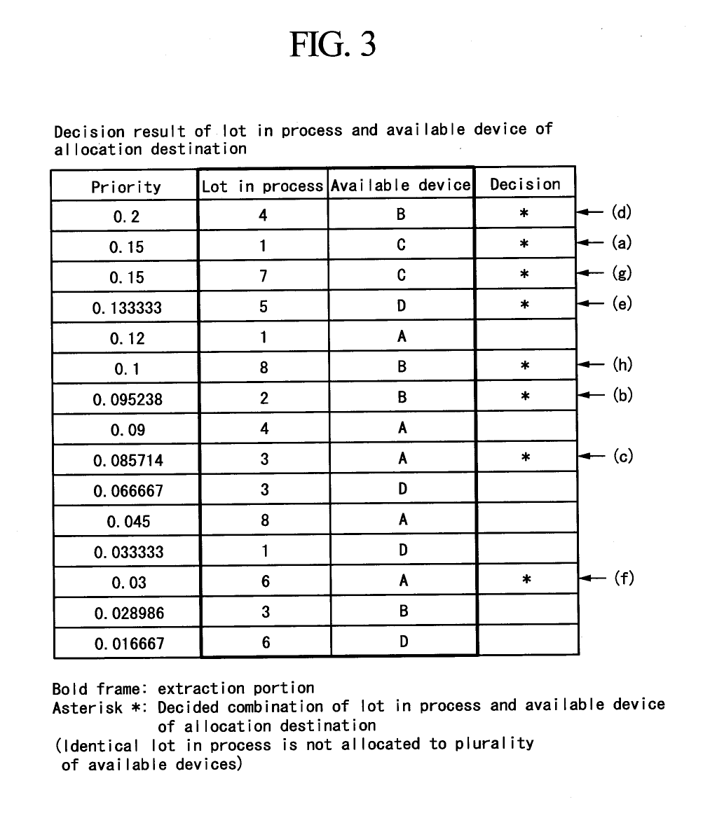

A work process control device 1 according to an embodiment of the present invention will now be described with reference to the drawings. FIG. 1 is an example of a functional block diagram showing the configuration of the work process control device 1 according to this embodiment. FIGS. 2A, 2B, and 3 are illustrative diagrams illustrating information generated by the work process control device 1.

The work process control device 1 controls (manages) work processes of a plurality of devices (Device Nos.) installed in a production line. The devices, which are control targets of the work process control device 1, constitute one or more device groups (for example, a device group which performs silicon dry etching and a defect inspection device group which detects a defect upon processing) by work processes respectively serving as targets. A certain device group may include a plurality of identical devices, may include a plurality of different devices, and may include a plurality of identical and different devices. Also, a certain device group includes a “workable device” in which work is possible and an “unworkable device” in which work is not possible depending on the work process.

As shown in FIG. 1, the work process control device 1 has a priority temporary-allocation unit 10, an empty device determination unit 20, a priority calculation information acquisition unit 30, and a lot allocation unit 40. The priority calculation information acquisition unit 30 has an available device-specific number-of-lots-in-process calculation unit 31, an available device-specific maximum possible working rate calculation unit 32, an available device-specific in-process-lot-specific standard work time calculation unit 33, and an in-process lot-specific number-of-available-devices calculation unit 34. The lot allocation unit 40 has a priority calculation unit 41 and an allocation decision unit 42.

If a lot for which work should be done is in process in a predetermined device group, the priority temporary-allocation unit 10 executes temporary allocation in priority processing (dispatch) of the lot in process according to a known rule such as first-in, first-out (FIFO). The lot in process is a lot which is actually in a work waiting state at the time.

The priority temporary-allocation unit 10 having executed the temporary allocation notifies the empty device determination unit 20 of the temporary allocation execution result, and acquires a determination result of the empty device determination unit 20 determining whether or not it is an empty device state from the empty device determination unit 20. For example, the temporary allocation execution result is information including a work start time and a work end time of each lot related to the temporary allocation for each device, that is, information constituting a device-specific lot-specific Gantt chart.

Upon acquisition of the determination result indicating the empty device state, the priority temporary-allocation unit 10 notifies the priority calculation information acquisition unit 30 of the temporary allocation execution result.

The empty device determination unit 20 acquires the temporary allocation execution result from the priority temporary-allocation unit 10. The empty device determination unit 20 having acquired the temporary allocation execution result determines whether or not it is the empty device state on the basis of a work state of each device within a device group and a current lot in process state (a situation based on the temporary allocation result). The empty device determination unit 20 notifies the priority temporary-allocation unit 10 of the determination result. The empty device determination unit 20 internally manages the work state of each device within the device group.

The available device-specific number-of-lots-in-process calculation unit 31 acquires the temporary allocation execution result from the priority temporary-allocation unit 10. The available device-specific number-of-lots-in-process calculation unit 31 having acquired the temporary allocation execution result calculates the number of available device-specific lots in process on the basis of the temporary allocation execution result. The number of available device-specific lots in process is the number of lots-in-process during the process of the device group, that is, the number of available device-specific lots in process available in processing of lots in process.

For example, the available device-specific number-of-lots-in-process calculation unit 31 calculates the number of available device-specific lots in process of an “in-process lot-available device list” shown in FIG. 2A. In the example shown in FIG. 2A, the available device-specific number-of-lots-in-process calculation unit 31 calculates the number of lots in process (5 (lots)) related to an available device A from 5 lots in process (a lot in process 1, a lot in process 3, a lot in process 4, a lot in process 6, and a lot in process 8) related to the available device A, and calculates the number of lots in process (4 (lots)) related to an available device B from 4 lots in process, such as a lot in process 2, the lot in process 3, the lot in process 4, and the lot in process 8, related to the available device B.

FIGS. 2A, 2B, and 3 are examples in which 8 lots, Nos. 1 to 8, are in process in a device group including 4 devices A, B, C, and D. Depending on each work process, an unworkable device is set for each lot in process, as indicated by a mark x in FIGS. 2A and 2B. For example, the lot in process 1 is workable in the available devices A, C, and D, but is unworkable in the available device B.

The available device-specific number-of-lots-in-process calculation unit 31 having calculated the number of available device-specific lots in process notifies the priority calculation unit 41 of the calculation result. The available device-specific number-of-lots-in-process calculation unit 31 may write the calculation result to an area capable of being referred to by the priority calculation unit 41 instead of notifying the priority calculation unit 41 of the calculation result. For example, the calculation result may be written to a workable device list when the priority calculation unit 41 can refer to an in-process lot-available device list.

The available device-specific maximum possible working rate calculation unit 32 acquires a temporary allocation execution result from the priority temporary-allocation unit 10. The available device-specific maximum possible working rate calculation unit 32 having acquired the temporary allocation execution result calculates an available device-specific maximum possible working rate based on an actual value, for example, calculates an average of actual values. The available device-specific maximum possible working rate is a maximum possible working rate of each available device. The available device-specific maximum possible working rate calculation unit 32 internally manages the actual value or acquires the actual value from the outside, and calculates the available device-specific maximum possible working rate, but may calculate the available device-specific maximum possible working rate if the actual value is updated.

For example, the available device-specific maximum possible working rate calculation unit 32 calculates the available device-specific maximum possible working rate of the “in-process lot-available device list” shown in FIG. 2A.

The available device-specific maximum possible working rate calculation unit 32 having calculated the available device-specific maximum possible working rate notifies the priority calculation unit 41 of a calculation result. The available device-specific maximum possible working rate calculation unit 32 may write the calculation result to an area capable of being referred to by the priority calculation unit 41 instead of notifying the priority calculation unit 41 of the calculation result. For example, the calculation result may be written to a workable device list when the priority calculation unit 41 can refer to the in-process lot-available device list.

The available device-specific in-process-lot-specific standard work time calculation unit 33 acquires the temporary allocation execution result from the priority temporary-allocation unit 10. The available device-specific in-process-lot-specific standard work time calculation unit 33 having acquired the temporary allocation execution result calculates an available device-specific in-process-lot-specific standard work time based on an actual value, for example, calculates an average of actual values. The available device-specific in-process-lot-specific standard work time is a standard work time of each available device and each lot in process. A device preparation time is a time, for example, an adjustment time or a gas preparation time, required for an operation of a device in which no lot is processed. The available device-specific in-process-lot-specific standard work time calculation unit 33 internally manages the actual value or acquires the actual value from the outside, and calculates the available device-specific in-process-lot-specific standard work time, but may calculate the available device-specific in-process-lot-specific standard work time if the actual value is updated.

For example, the available device-specific in-process-lot-specific standard work time calculation unit 33 calculates a value of each cell within the bold frame of the “in-process lot-available device list” shown in FIG. 2A as the available device-specific in-process-lot-specific standard work time.

The available device-specific in-process-lot-specific standard work time calculation unit 33 having calculated the available device-specific in-process-lot-specific standard work time notifies the priority calculation unit 41 of the calculation result. The available device-specific in-process-lot-specific standard work time calculation unit 33 may write the calculation result to an area capable of being referred to by the priority calculation unit 41 instead of notifying the priority calculation unit 41 of the calculation result. For example, the calculation result may be written to a workable device list when the priority calculation unit 41 can refer to the in-process lot-available device list.

The in-process-lot-specific number-of-available-devices calculation unit 34 acquires the temporary allocation execution result from the priority temporary-allocation unit 10. The in-process-lot-specific number-of-available-devices calculation unit 34 having acquired the temporary allocation execution result calculates the number of in-process-lot-specific available devices based on the temporary allocation execution result. The number of in-process-lot-specific available devices is the number of available devices of each lot in process.

For example, the in-process-lot-specific number-of-available-devices calculation unit 34 calculates the number of in-process-lot-specific available devices in the “in-process lot-available device list” shown in FIG. 2A. In the example shown in FIG. 2A, the in-process-lot-specific number-of-available-devices calculation unit 34 calculates the number of available devices, “3,” related to a lot in process 1 from 3 available devices (an available device A, an available device C, and an available device D), and calculates the number of available devices, “1,” related to a lot in process 2 from 1 available device (the available device B) related to the lot in process 2.

The in-process-lot-specific number-of-available-devices calculation unit 34 having calculated the number of in-process-lot-specific available devices notifies the priority calculation unit 41 of the calculation result. The in-process-lot-specific number-of-available-devices calculation unit 34 may write the calculation result to an area capable of being referred to by the priority calculation unit 41 instead of notifying the priority calculation unit 41 of the calculation result. For example, the calculation result may be written to a workable device list when the priority calculation unit 41 can refer to the in-process lot-available device list.

The priority calculation unit 41 acquires the calculation results calculated by the priority calculation information acquisition unit 30. The priority calculation information acquisition unit 30 may include, but is not limited to, the available device-specific number-of-lots-in-process calculation unit 31, the available device-specific maximum possible working rate calculation unit 32, the available device-specific in-process-lot-specific standard work time calculation unit 33, and the in-process-lot-specific number-of-available-devices calculation unit 34. On the basis of the calculation results, the priority calculation unit 41 having acquired the calculation results calculates an available device-specific in-process-lot-specific priority. Specifically, the priority calculation unit 41 calculates an available device-specific in-process-lot-specific priority according to the following Equation (1).

Priority=A2/(A1×A3×A4) (1)

where A1 represents the calculation result by the available device-specific number-of-lots-in-process calculation unit 31 (that is, the number of available device-specific lots in process), A2 represents the calculation result by the available device-specific maximum possible working rate calculation unit 32, that is, the available device-specific maximum possible working rate, A3 represents the calculation result by the available device-specific in-process-lot-specific standard work time calculation unit 33, that is, the available device-specific in-process-lot-specific standard work time, and A4 represents the calculation result by the in-process-lot-specific number-of-available-devices calculation unit 34, that is, the number of in-process-lot-specific available devices.

For example, the priority calculation unit 41 refers to the “in-process lot-available device list” shown in FIG. 2A calculated by the priority calculation information acquisition unit 30, and generates a “priority table” shown in FIG. 2B. In the example shown in FIG. 2B, the priority calculation unit 41 calculates a priority, “0.12” (=0.9/(5×0.5×3)), related to the available device A and the lot in process 1 from A1=the number of lots in process, “5,” related to the available device A, A2=a maximum possible working rate, “0.9,” related to the available device A, A3=a standard work time, “0.5 (hours),” related to the available device A and the lot in process 1, and A4=the number of available devices, “3,” related to the lot in process 1, and calculates a priority, “0.15” (=0.9/(2×3×1)), related to the available device C and the lot in process 7 from A1=the number of lots in process, “2,” related to the available device C, A2=a maximum possible working rate, “0.9,” related to the available device C, A3=a standard work time, “3 (hours),” related to the available device C and the lot in process 7, and A4=the number of available devices, “1”, related to the lot in process 7.

The available device-specific in-process-lot-specific priority means that the number of empty devices within the device group in which work is preferentially done for the lot in process decreases when the number of lots in process for each available device decreases, when an operating ratio for each available device increases, when a standard work time in the available device of each lot in process decreases, and when the number of available devices of each lot in process decreases.

The priority calculation unit 41 having calculated the available device-specific in-process-lot-specific priority notifies the allocation decision unit 42 of priority information indicating a priority as the calculation result. Also, the priority calculation unit 41 may write the priority to an area capable of being referred to by the allocation decision unit 42 instead of notifying the allocation decision unit 42 of the priority information. For example, a priority may be written to the priority table when the allocation decision unit 42 can refer to the priority table.

The allocation decision unit 42 acquires the available device-specific in-process-lot-specific priority calculated by the priority calculation unit 41. The allocation decision unit 42 having acquired the available device-specific in-process-lot-specific priority decides an available device as an allocation destination of each lot in process based on the priority.

First, the allocation decision unit 42 extracts a combination having elements of a lot in process and an available device as a candidate of a combination of a lot in process and an available device of an allocation destination in descending order of priority, and may extract a combination having elements of a lot in process and an available device associated with a priority and sort each combination in descending order of priority.

For example, the allocation decision unit 42 refers to the “priority table” shown in FIG. 2B and extracts a combination having elements of a lot in process and an available device in descending order of priority as shown in the bold frame of FIG. 3. For example, since a priority, “0.2,” related to the available device B and the lot in process 4 is maximal in FIG. 2B, the allocation decision unit 42 initially extracts a combination having elements of the lot in process 4 and the available device B as shown in FIG. 3. Since a priority, “0.15,” related to the available device C and the lot in process 1 and a priority, “0.15,” related to the available device C and the lot in process 7 are the next place in FIG. 2B, the allocation decision unit 42 first extracts any one thereof as shown in FIG. 3. Extraction is performed in descending order of lot in process No. in the example of FIG. 3.

As shown in FIG. 3, the allocation decision unit 42 may extract a combination having elements of a lot in process and an available device associated with a priority. That is, a combination having elements of a priority, a lot in process, and an available device may be extracted.

Subsequently, the allocation decision unit 42 selects combinations one by one in descending order of priority until all lots in process are selected as an element of any combination from among a plurality of combinations extracted as candidates (excluding a combination having an element of a lot in process already selected as an element of any combination), and decides a combination of a lot in process and an available device of an allocation destination. That is, the allocation decision unit 42 decides an available device of an allocation destination of a lot in process in descending order of priority.

For example, in the example shown in FIG. 3, first, the allocation decision unit 42 selects a combination, the lot in process 4 and the available device B, and decides the available device B as an allocation destination of the lot in process 4. Next, the allocation decision unit 42 selects a combination (the lot in process 1 and the available device C), and decides the available device C as an allocation destination of the lot in process 1. Thereafter, likewise, combinations are selected one by one in descending order of priority until all lots in process are selected as an element of any combination from among a plurality of combinations extracted as candidates, excluding a combination having an element of a lot in process already selected as an element of any combination, and allocation destinations of all the lots in process are decided. An asterisk (*) attached to a decision field of FIG. 3 indicates the decision of allocation.

Thus, the allocation decision unit 42 decides an available device as an allocation destination of each lot in process by extracting combinations of lots in process and available devices of allocation destinations and sequentially selecting the combinations one by one in descending order of available device-specific in-process-lot-specific priorities corresponding to the respective combinations from among the extracted combinations. Alternatively, the allocation decision unit 42 decides an available device as an allocation destination of each lot in process by extracting combinations of lots in process and available devices of allocation destinations associated with available device-specific in-process-lot-specific priorities and sequentially selecting the combinations one by one in descending order of the priorities.

In other words, as shown in FIGS. 2B and 3, the allocation decision unit 42 selects one available device having a highest priority, or one available device when a priority related to the available device and a lot in process is highest, as an available device of an allocation destination of one lot in process from among priorities related to the lot in process, available device-specific in-process-lot-specific priorities related to the lot in process and any available device, that is, priorities related to any available device and the lot in process.

For example, as shown in FIGS. 2B and 3, the allocation decision unit 42 selects the available device C having a highest priority as an available device of an allocation destination of the lot in process 1 from among 3 priorities related to the lot in process 1 (a priority, “0.12,” related to the available device A and the lot in process 1, a priority, “0.15,” related to the available device C and the lot in process 1, and a priority, “0.033333,” related to the available device D and the lot in process 1) (see (a) of FIG. 3).

The allocation decision unit 42 selects the available device B having a highest priority as an available device of an allocation destination of the lot in process 2 from one priority related to the lot in process 2 (a priority, “0.095238,” related to the available device B and the lot in process 2) (see (b) of FIG. 3).

The allocation decision unit 42 selects the available device A having a highest priority as an available device of an allocation destination of the lot in process 3 from among 3 priorities related to the lot in process 3 (a priority, “0.085714,” related to the available device A and the lot in process 3, a priority, “0.028986,” related to the available device B and the lot in process 3, and a priority, “0.066667,” related to the available device D and the lot in process 3) (see (c) of FIG. 3).

Likewise, the allocation decision unit 42 selects the available device B as an available device of an allocation destination of the lot in process 4 (see (d) of FIG. 3), selects the available device D as an available device of an allocation destination of the lot in process 5 (see (e) of FIG. 3), selects the available device A as an available device of an allocation destination of the lot in process 6 (see (f) of FIG. 3), selects the available device C as an available device of an allocation destination of the lot in process 7 (see (g) of FIG. 3), and selects the available device B as an available device of an allocation destination of the lot in process 8 (see (h) of FIG. 3).

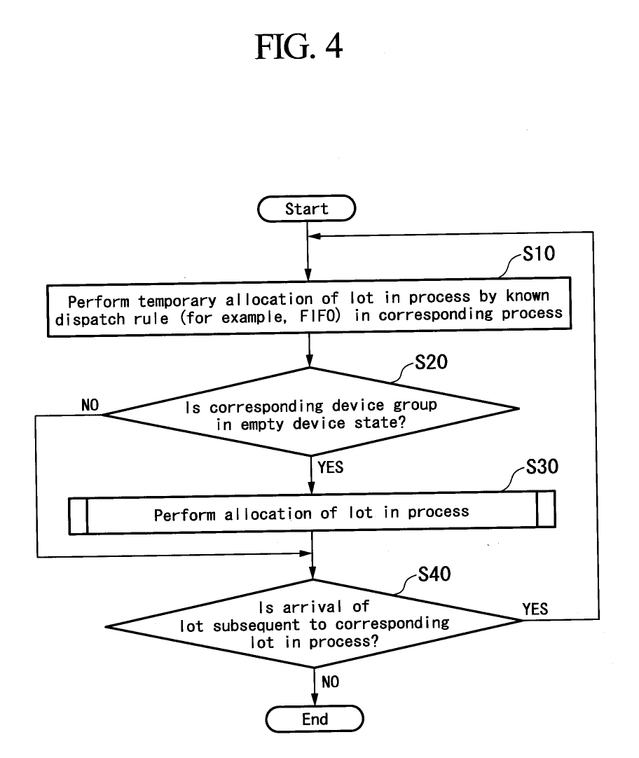

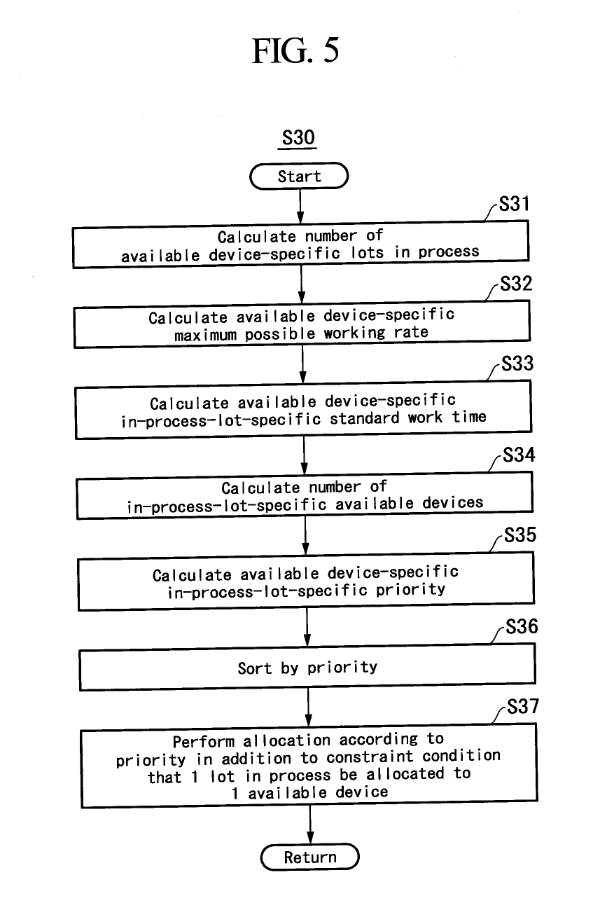

Hereinafter, the operation of the work process control device 1 using the flowcharts shown in FIGS. 4 and 5 will be described. The flowchart shown in FIG. 4 begins when a specific device group to do work is in process, that is, when a lot in process is generated.

In FIG. 4, the priority temporary-allocation unit 10 executes temporary allocation in priority processing (dispatch) of a lot in process according to a known rule such as FIFO (step S10). The priority temporary-allocation unit 10 having executed the temporary allocation notifies the empty device determination unit 20 of the temporary allocation execution result.

The empty device determination unit 20 having acquired the temporary allocation execution result determines whether or not it is an empty device state on the basis of a work state of each device within the device group and a current lot in process state (a situation based on the temporary allocation result) (step S20). The empty device determination unit 20 notifies the priority temporary-allocation unit 10 of the determination result.

If the determination result indicating the empty device state is acquired from the empty device determination unit 20, that is, if the empty device determination unit 20 determines that it is the empty device state (step S20: Yes), the priority temporary-allocation unit 10 notifies the priority calculation information acquisition unit 30 of the temporary allocation execution result, and the priority calculation information acquisition unit 30 and the lot allocation unit 40 execute a process of allocating a lot in process (step S30). Details of an operation (algorithm) of allocating a corresponding lot in process by the priority calculation information acquisition unit 30 and the lot allocation unit 40 will be described later (see FIG. 5).

If the determination result indicating a non-empty device state is acquired from the empty device determination unit 20, that is, if the empty device determination unit 20 determines that it is not the empty device state (step S20: No), in step S30, the priority temporary-allocation unit 10 determines whether or not a lot other than a corresponding lot arrives, that is, determines whether a lot in process is newly generated (step S40).

If it is determined that the lot other than the corresponding lot arrives (step S40: Yes), the priority temporary-allocation unit 10 returns to step S10. On the other hand, if it is determined that the lot other than the corresponding lot does not arrive (step S40: No), the flowchart is terminated. When the lot in process is newly generated, the priority temporary-allocation unit 10 resumes the flowchart of FIG. 4.

In FIG. 5, the available device-specific number-of-lots-in-process calculation unit 31 having acquired the temporary allocation execution result from the priority temporary-allocation unit 10 calculates the number of available device-specific lots in process on the basis of the temporary allocation execution result (step S31). The available device-specific number-of-lots-in-process calculation unit 31 having calculated the number of available device-specific lots in process notifies the priority calculation unit 41 of the calculation result.

The available device-specific maximum possible working rate calculation unit 32 having acquired the temporary allocation execution result from the priority temporary-allocation unit 10 calculates an available device-specific maximum possible working rate based on the temporary allocation execution result (step S32). The available device-specific maximum possible working rate calculation unit 32 having calculated the available device-specific maximum possible working rate notifies the priority calculation unit 41 of the calculation result.

The available device-specific in-process-lot-specific standard work time calculation unit 33 having acquired the temporary allocation execution result from the priority temporary-allocation unit 10 calculates an available device-specific in-process-lot-specific standard work time on the basis of the temporary allocation execution result (step S33). The available device-specific in-process-lot-specific standard work time calculation unit 33 having calculated the available device-specific in-process-lot-specific standard work time notifies the priority calculation unit 41 of the calculation result.

The in-process-lot-specific number-of-available-devices calculation unit 34 having acquired the temporary allocation execution result from the priority temporary-allocation unit 10 calculates the number of in-process-lot-specific available devices on the basis of the temporary allocation execution result (step S34). The in-process-lot-specific number-of-available-devices calculation unit 34 having calculated the number of in-process-lot-specific available devices notifies the priority calculation unit 41 of the calculation result.

On the basis of each calculation result, the priority calculation unit 41 having acquired each calculation result calculates an available device-specific in-process-lot-specific priority according to the above-described Equation (1) (step S35). The priority calculation unit 41 having calculated the available device-specific in-process-lot-specific priority notifies the allocation decision unit 42 of priority information indicating a priority as the calculation result.

The allocation decision unit 42 having acquired the available device-specific in-process-lot-specific priority extracts a combination having elements of a lot in process and an available device as a candidate of a combination of a lot in process and an available device of an allocation destination in descending order of the priority. That is, the allocation decision unit 42 sorts a candidate of a combination of a lot in process and an available device of an allocation destination in order of priority (step S36).

The allocation decision unit 42 decides the available device as the allocation destination of the lot in process in descending order of priority (step S37). Specifically, the allocation determination unit 42 selects combinations one by one in descending order of priority until all lots in process are selected as an element of any combination from among a plurality of combinations extracted as candidates (excluding a combination having an element of a lot in process already selected as an element of any combination), and decides a combination of a lot in process and an available device of an allocation destination. In other words, the allocation decision unit 42 performs allocation according to a priority in addition to a constraint condition that 1 lot in process is allocated to 1 available device. The flowchart of FIG. 5 is terminated, and it proceeds to step S40 of FIG. 4. The allocation decision unit 42 having decided the available device as the allocation destination of the lot in process notifies each available device of the decision result related to allocation, and each available device starts work on the basis of the decision result.

The above-described steps (algorithm) may be taken in a simulator or scheduler such that a lot in process may be automatically allocated.

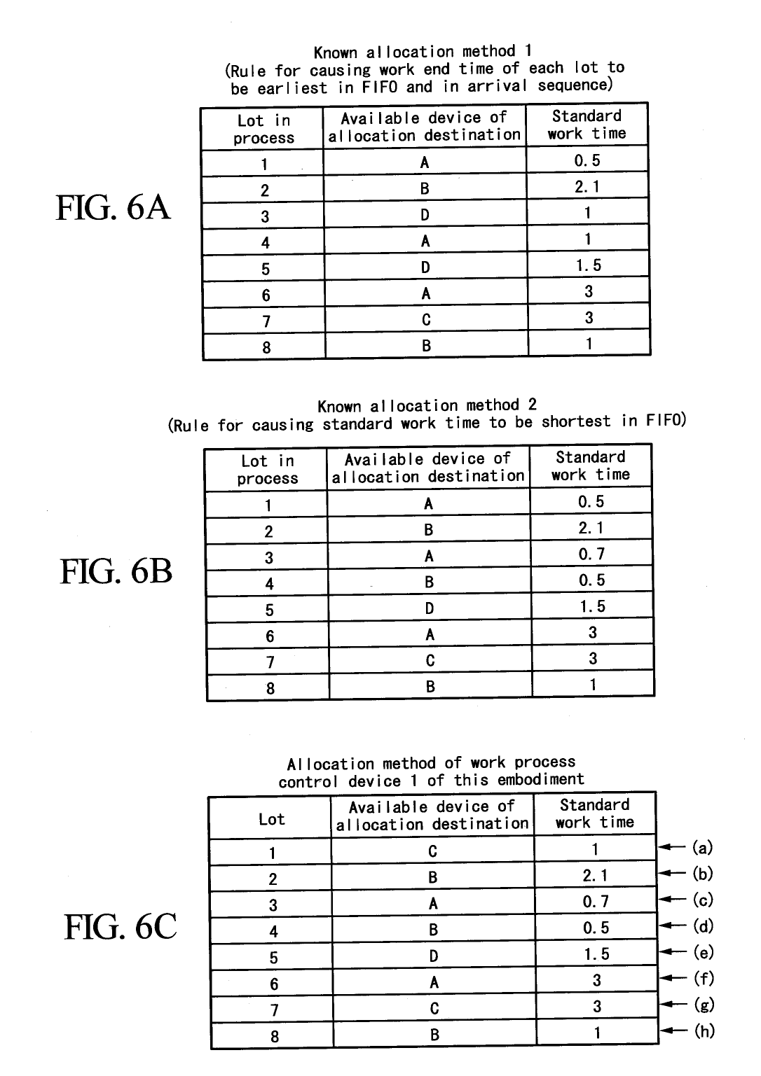

An allocation method by the work process control device 1 and another known allocation method will be compared and described using FIG. 6. The allocation result of FIG. 6 is an example of an allocation result by each method when lots 1 to 8 arrive according to a correspondence sequence and are in process as in FIG. 2A.

### Method 1:

The method 1 is a method to which a rule for causing a work end time of each lot to be earliest in an arrival sequence and in FIFO is applied. A lot allocated to each device in the method 1 is shown in FIG. 6A.

Accordingly, since the available device A executes the lot in process 1, the lot in process 4, and the lot in process 6, the work ends after 4.5 (hours) have elapsed. Since the available device B executes the lot in process 2 and the lot in process 8, the work ends after 3.1 (hours) have elapsed. Since the available device C executes the lot in process 7, the work ends after 3 (hours) have elapsed. Since the available device D executes the lot in process 3 and the lot in process 5, the work ends after 2.5 (hours) have elapsed. Accordingly, the work of all lots in process ends after 4.5 (hours), which is the latest work end time of the available device A, have elapsed.

In FIG. 6A, the first arrived lot in process 1 is allocated to the available device A having the earliest work end time since the work end time is “after 0.5 (hours)” (a standard work time “0.5 (hours)” related to the available device A and the lot in process 1) when the lot in process 1 is allocated to the available device A, the work end time is “after 1 (hour)” (a standard work time “1 (hour)” related to the available device C and the lot in process 1) when the lot in process 1 is allocated to the available device C, and the work end time is “after 2 (hours)” (a standard work time “2 (hours)” related to the available device D and the lot in process 1) when the lot in process 1 is allocated to the available device D.

Since the second arrived lot in process 2 can be allocated only to the available device B, the lot in process 2 is allocated to the available device B.

The third arrived lot in process 3 is allocated to the available device D having the earliest work end time since the work end time is “after 1.2 (hours)” (a sum of a standard work time “0.5 (hours)” related to the available device A and the lot in process 1 and a standard work time “0.7 (hours)” related to the available device A and the lot in process 3) when the lot in process 3 is allocated to the available device A, the work end time is “after 4.4 (hours)” (a sum of a standard work time “2.1 (hour)” related to the available device B and the lot in process 2 and a standard work time “2.3 (hour)” related to the available device B and the lot in process 3) when the lot in process 3 is allocated to the available device B, and the work end time is “after 1 (hour)” (a standard work time “1 (hour)” related to the available device D and the lot in process 3) when the lot in process 3 is allocated to the available device D.

The fourth arrived lot in process 4 is allocated to the available device A having the earliest work end time since the work end time is “after 1.5 (hours)” (a sum of a standard work time “0.5 (hours)” related to the available device A and the lot in process 1 and a standard work time “1 (hour)” related to the available device A and the lot in process 4) when the lot in process 4 is allocated to the available device A, and the work end time is “after 2.6 (hours)” (a sum of a standard work time “2.1 (hour)” related to the available device B and the lot in process 2 and a standard work time “0.5 (hours)” related to the available device B and the lot in process 4) when the lot in process 4 is allocated to the available device B.

Since the fifth arrived lot in process 5 can be allocated only to the available device D, the lot in process 5 is allocated to the available device D.

The sixth arrived lot in process 6 is allocated to the available device A having the earliest work end time since the work end time is “after 4.5 (hours)” (a sum of a standard work time “0.5 (hours)” related to the available device A and the lot in process 1, a standard work time “1 (hour)” related to the available device A and the lot in process 4, and a standard work time “3 (hours)” related to the available device A and the lot in process 6) when the lot in process 6 is allocated to the available device A, and the work end time is “after 8.5 (hours)” (a sum of a standard work time “1 (hour)” related to the available device D and the lot in process 3, a standard work time “1.5 (hour)” related to the available device D and the lot in process 5, and a standard work time “6 (hours)” related to the available device D and the lot in process 6) when the lot in process 6 is allocated to the available device D.

Since the seventh arrived lot in process 7 can be allocated only to the available device C, the lot in process 7 is allocated to the available device C.

The eighth arrived lot in process 8 is allocated to the available device B having the earliest work end time since the work end time is “after 6.5 (hours)” (a sum of a standard work time “0.5 (hours)” related to the available device A and the lot in process 1, a standard work time “1 (hour)” related to the available device A and the lot in process 4, a standard work time “3 (hours)” related to the available device A and the lot in process 6, and a standard work time “2 (hours)” related to the available device A and the lot in process 6) when the lot in process 8 is allocated to the available device A, and the work end time is “after 3.1 (hours)” (a sum of a standard work time “2.1 (hours)” related to the available device B and the lot in process 2 and a standard work time “1 (hour)” related to the available device B and the lot in process 8) when the lot in process 8 is allocated to the available device B.

### Method 2:

The method 2 is a method to which a rule for causing a standard work time of each lot to be shortest in FIFO is applied. In the method 2, a lot allocated to each device is shown in FIG. 6B.

Accordingly, since the available device A executes the lot in process 1, the lot in process 3, and the lot in process 6, the work ends after 4.2 (hours) have elapsed. Since the available device B executes the lot in process 2, the lot in process 4, and the lot in process 8, the work ends after 3.6 (hours) have elapsed. Since the available device C executes the lot in process 7, the work ends after 3 (hours) have elapsed. Since the available device D executes the lot in process 5, the work ends after 1.5 (hours) have elapsed. Accordingly, the work of all lots in process ends after 4.2 (hours), which is the latest work end time of the available device A, have elapsed.

### Allocation Method by Work Process Control Device 1:

On the other hand, the allocation method by the work process control device 1 is shown in FIG. 6C according to FIG. 3. (c) and (d) of FIG. 6C correspond to (c) and (d) of FIG. 3.

Accordingly, since the available device A executes the lot in process 3 and the lot in process 6, the work ends after 3.7 (hours) have elapsed. Since the available device B executes the lot in process 2, the lot in process 4, and the lot in process 8, the work ends after 3.6 (hours) have elapsed. Since the available device C executes the lot in process 7, the work ends after 4 (hours) have elapsed. Since the available device D executes the lot in process 5, the work ends after 1.5 (hours) have elapsed. Accordingly, the work of all lots in process ends after 4 (hours), which is the latest work end time of the available device C, have elapsed. In this case, the work end time is earlier than that of the method 1 of 4.5 (hours) and that of the method 2 of 4.2 (hours).

As described above, the allocation method of the work process control device 1 can shorten the TAT until the work of all device groups ends as compared with the allocation methods of the known methods 1 and 2. The allocation method of the work process control device 1 shortens the TAT until the work of all device groups ends so that an available device for which the number of available device-specific lots in process is smaller (the number of unworkable processes is larger) is efficiently used. For example, as shown in FIG. 6, only the lot in process 7 is allocated to the available device C for which the number of available device-specific lots in process is smallest (the number of unworkable processes is largest) in the allocation methods of the known methods 1 and 2, but the lot in process 1 and the lot in process 7 are allocated in the allocation method of the work process control device 1.

The work process control device 1 will be further described through a comparison with a technique of the above-described Japanese Unexamined Patent Application Publication No. 2005-301653.

### Case of Technique of Japanese Unexamined Patent Application Publication No. 2005-301653:

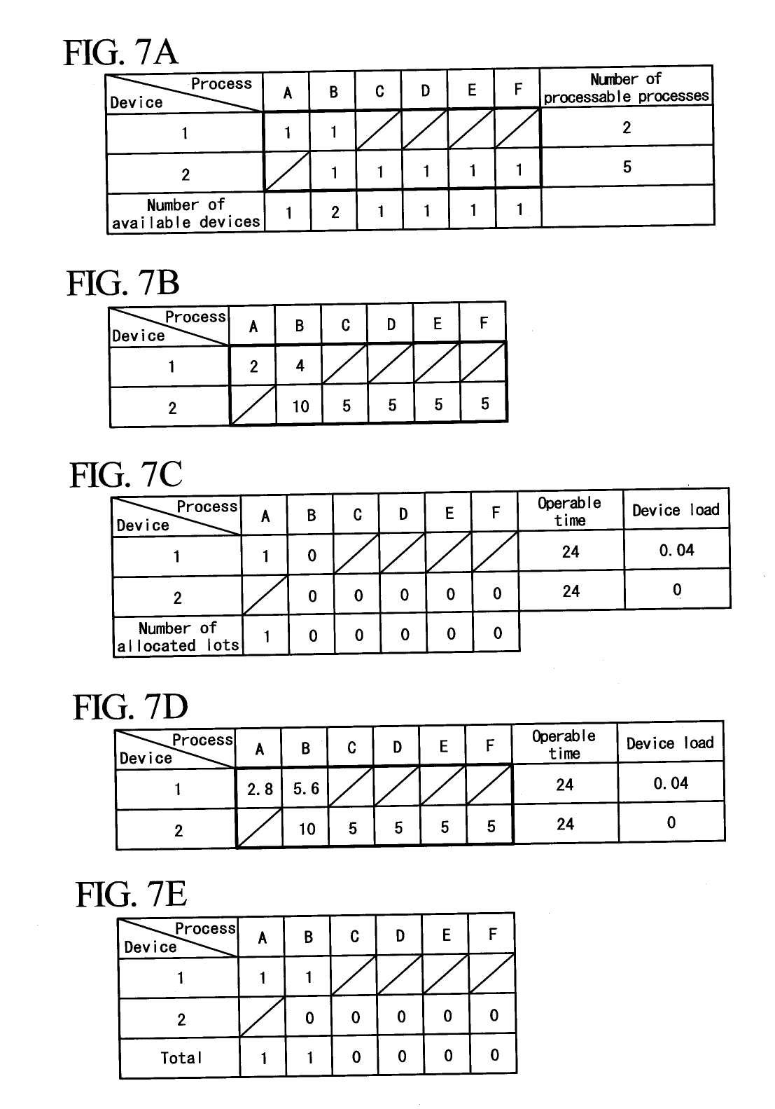

In the technique of Japanese Unexamined Patent Application Publication No. 2005-301653, for example, when allocation destinations of processes A and B are decided in a device group including a device 1 and a device 2, other processes C, D, E, and F workable in the device 1 or 2 affect the decision of the allocation destinations. That is, a process device list is the same as shown in FIG. 7A when the technique of Japanese Unexamined Patent Application Publication No. 2005-301653 is applied. The process device list of FIG. 7A corresponds to the in-process lot-available device list shown in FIG. 2A, and a value of each cell within the bold frame of FIG. 7A is a processing time (standard work time).

In the technique of Japanese Unexamined Patent Application Publication No. 2005-301653, an initial value of a priority is calculated according to Priority (Initial Value)=Processing Time×Number of Available Devices×Number of Workable processes as shown in FIG. 7B. A value of each cell within the bold frame of FIG. 7B is an initial value of a priority. For example, a priority (initial value), “2,” of the device 1 and the process A is calculated from Processing Time “1”×Number of Available Devices “1”×Number of Workable processes “2.” A priority (initial value), “10,” of the device 2 and the process B is calculated from Processing Time “1”×Number of Available Devices “2”×Number of Workable processes “5.”

When both values of the number of lots of a unit time (for example, 1 day) of the processes A and B are 1, 1 lot of the process A is allocated (reserved) to the device 1 as shown in FIG. 7C in the technique of Japanese Unexamined Patent Application Publication No. 2005-301653. Next, a device load of each device is calculated according to Device Load=Processing Time×Number of Allocated Lots÷Operable Time as shown in FIG. 7C. For example, a device load, “0.04,” of the device 1 is calculated from Processing Time “1”×Number of Allocated Lots “1”÷Operable Time “24,” and the device load “0” of the device 2 is calculated from Processing Time “1”×Number of Allocated Lots “0”÷Operable Time “24.”

In the technique of Japanese Unexamined Patent Application Publication No. 2005-301653, an update value of a priority is calculated according to Priority (Update Value)=Priority (Initial Value)×{(Device Load×10)^{k}+1} as shown in FIG. 7D. A value of each cell within the bold frame of FIG. 7D is an update value of a priority. For example, a priority (update value), “2.8,” of the device 1 and the process A is calculated from Priority (Initial Value) “2”×{(0.04×10)¹+1}, and a priority (update value), “10,” of the device 2 and the process B is calculated from Priority (Initial Value) “10”×{(0×10)¹+1}. In FIG. 7D, k=1, but it is preferable that k be a positive integer.

In the technique of Japanese Unexamined Patent Application Publication No. 2005-301653, 1 lot of the process B is allocated to the device 1 as shown in FIG. 7E. That is, in the technique of Japanese Unexamined Patent Application Publication No. 2005-301653, a lot of the process B as well as a lot of the process A is allocated to the device 1. In other words, the device 1 processes the lot of the process B as well as the lot of the process A.

### Case of Work Process Control Device 1:

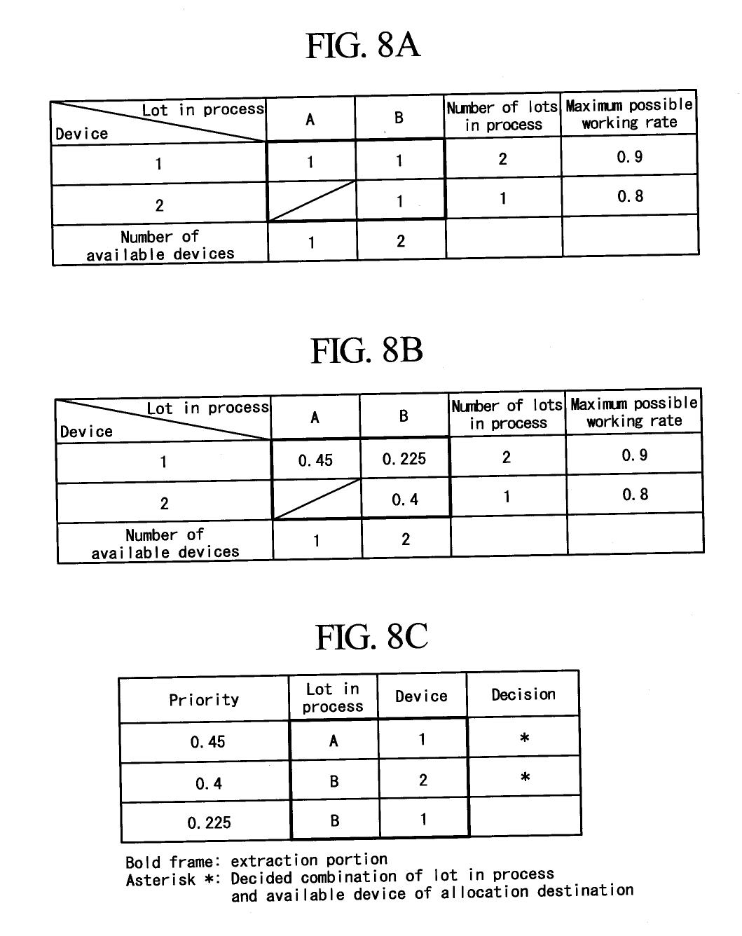

For a comparison with the technique of Japanese Unexamined Patent Application Publication No. 2005-301653, each process shown in FIGS. 7A to 7E is replaced with a lot as shown in FIGS. 8A to 8C for convenience. For the comparison, description of FIGS. 8A to 8C also has the same condition as that of FIGS. 7A to 7E, both values of the number of lots of the unit time (for example, 1 day) of the processes A and B are 1.

For example, in the work process control device 1, when allocation destinations of lots A and B are decided in a device group including a device 1 and a device 2, other lots C, D, E, and F workable in the device 1 or 2 do not affect the decision of the allocation destinations. That is, for example, an in-process lot-available device list is the same as shown in FIG. 8A when the work process control device 1 is applied. A value of each cell within the bold frame of FIG. 8A is a processing time (standard work time). As shown in FIGS. 8A, 8B, and 8C in terms of lots in process A and B, both of the lots A and B are workable in the device 1 (assignable thereto), and only the lot B is workable in the device 2 (assignable thereto).

The work process control device 1 calculates a priority according to Priority=Maximum possible working rate/(Number of Lots in process×Standard Work Time×Number of Available Devices) as shown in FIG. 8B. A value of each cell within the bold frame of FIG. 7B is a priority. For example, a priority, “0.45,” of the device 1 and the process A is calculated from Maximum possible working rate “0.9”/(Number of Lots in process “2”×Standard Work Time “1”×Number of Available Devices “1”), and a priority, “0.4,” of the device 2 and the process B is calculated from Maximum possible working rate “0.8”/(Number of Lots in process “1”×Standard Work Time “1”×Number of Available Devices “2”).

The work process control device 1 extracts a combination having elements of a lot in process and an available device as a candidate of a combination of a lot in process and an available device of an allocation destination in descending order of priority and decides an available device of an allocation destination as shown in FIG. 8C. An extraction portion is shown within the bold frame of FIG. 8C, and an asterisk (*) attached to the decision field indicates the decision of allocation. That is, the work process control device 1 allocates a lot in process A to the device 1 and allocates a lot in process B to the device 2. In other words, the device 1 processes the lot A and the device 2 processes the lot B.

As described above, the allocation by the technique of Japanese Unexamined Patent Application Publication No. 2005-301653 is different from the allocation of the work process control device 1 in terms of whether or not a process (lot) in which work is not actually generated affects the decision of an allocation destination. In further detail, in Japanese Unexamined Patent Application Publication No. 2005-301653, the number of available devices related to processes processable regardless of whether or not work is actually generated and the number of workable processes accounting for the workable processes are used as priority calculation parameters. However, a difference in the work process control device 1 is that the number of available devices related to only lots (that is, lots in process) in which work is actually generated and the number of lots in process accounting for the lots are used. In other words, the work process control device 1 is different from the technique of Japanese Unexamined Patent Application Publication No. 2005-301653 in that a target (lot) is focused on from a point of view of whether or not work is actually generated.

By the above-described difference, the work process control device 1 can implement efficient allocation as compared with the technique of Japanese Unexamined Patent Application Publication No. 2005-301653. For example, in the allocation by the technique of Japanese Unexamined Patent Application Publication No. 2005-301653, the process B and the process A can be allocated to the device 1, and the device 2 is not operated (the standby time of the device 2 is unnecessary) as shown in FIGS. 7A to 7E. However, the allocation of the work process control device 1 becomes efficient since the device 1 processes the lot A and the device 2 processes the lot B. The work process control device 1 is advantageous in that a process of calculating priorities related to C, D, E, and F is absent since a work target is first focused on.

According to the work process control device 1 of this embodiment, since a device of an allocation destination of each lot is decided using the number of available devices related to lots in which work is actually generated and the number of lots in process accounting for only the lots, an optimal device for processing each lot can be decided so that there is no empty device state even when an unworkable device is complexly set in a certain device group. Since the device of an allocation destination is decided by focusing on a lot in which work is actually generated (specifically, since the device of an allocation destination is decided by multiplying a reciprocal of the number of available device-specific lots in process, a reciprocal of an available device-specific in-process-lot-specific standard work time, an available device-specific maximum possible working rate, and a reciprocal of the number of in-process-lot-specific available devices), a calculation amount becomes small as compared with a simulation or a search for covering all patterns. Accordingly, it is possible to more efficiently produce a semiconductor device by further shortening a time necessary for processing of each lot. In other words, a device operating ratio is raised, thereby contributing to the improvement of productivity. Since an optimal workable device can be automatically selected when it is incorporated into a scheduler, manpower is unnecessary.

In the above-described Japanese Unexamined Patent Application Publication No. 2005-301653, allocation of a lot in which the empty device state is absent may not be possible. As described above, this is because a target range is set to all existing processes when an initial value is calculated and whether or not a lot for which work is to be done in each device is in process is neglected in the above-described Japanese Unexamined Patent Application Publication No. 2005-301653

In this embodiment, the priority calculation unit 41 calculates an available device-specific in-process-lot-specific priority according to the above-described Equation (1), but it is preferable that the priority calculated by the priority calculation unit 41 be a value proportional to a value obtained by multiplying a reciprocal of the number of available device-specific lots in process, a reciprocal of an available device-specific in-process-lot-specific standard work time, an available device-specific maximum possible working rate, and a reciprocal of the number of in-process-lot-specific available devices. For example, the priority calculation unit 41 may calculate an available device-specific in-process-lot-specific priority according to the following Equation (2) or (3) instead of the above-described Equation (1). In the following Equations (2) and (3), K, K₁, K₂, K₃, and K₄ are each coefficients, and A1, A2, A3, and A4 are respectively the same as those of the above-described Equation (1).

Priority=(K×A2)/(A1×A3×A4) (2)

Priority=(K₂×A2)/{(K₁×A1)×(K₃×A3)×(K₄×A4)} (3)

In this embodiment, the work process control device 1 includes the priority temporary-allocation unit 10, the empty device determination unit 20, the priority calculation information acquisition unit 30, and the lot allocation unit 40 as shown in FIG. 1, but it is preferable that the work process control device 1 include at least the lot allocation unit 40. The lot allocation unit 40 includes the priority calculation unit 41 and the allocation decision unit 42.

For example, if the work process control device 1 includes only the lot allocation unit 40, the priority calculation unit 41 acquires the number of available device-specific lots in process, an available device-specific maximum possible working rate, an available device-specific in-process-lot-specific standard work time, and the number of in-process-lot-specific available devices from an external device having the priority calculation information acquisition unit 30, and calculates an available device-specific in-process-lot-specific priority. The external device having the priority calculation information acquisition unit 30 may further include the priority temporary-allocation unit 10 and the empty device determination unit 20, may internally generate a temporary allocation execution result, and may acquire the temporary allocation execution result from the external device (a device different from the work process control device 1) having the priority temporary-allocation unit 10 and the empty device determination unit 20.

A program for executing each process of the work process control device 1 according to an embodiment of the present invention may be recorded on a computer-readable recording medium, and various processes related to each process of the work process control device 1 according to the embodiment of the present invention may be executed by reading the program recorded on this recording medium into a computer system. Here, the “computer system” may also include an operating system (OS) and hardware such as peripheral devices. When a WWW system is used, the “computer system” also includes a homepage provision environment (or display environment). Moreover, the “computer-readable recording medium” refers to a writable non-volatile memory such as a flexible disc, a magneto-optical disc, a ROM, or a flash memory, a portable medium such as a CD-ROM, or a memory device such as a hard disc built into the computer system.

Furthermore, the “computer readable storage medium” also includes a medium, which holds a program for a given time, such as a volatile memory (for example, a dynamic random access memory (DRAM)) inside a computer system which becomes a server or a client when the program is sent via a network such as the Internet or a communication circuit such as a telephone circuit. The above-described program may be transmitted from a computer system where the program is stored in a memory device or the like to another computer system via a transmission medium, or by transmission waves within the transmission medium. Here, for example, the “transmission medium” on which the program is transmitted is a medium having an information transmission function like a network (communication network) such as the Internet or a communication circuit (communication line) such as a telephone circuit. The above-described program may be used to implement a part of the above-described function. In addition, the program may be a so-called differential file (differential program) capable of implementing the above-described function in combination with a program already recorded on the computer system.

The embodiments of the present invention have been described in detail with reference to the drawings. However, specific configurations are not limited to the embodiments and may include any design in the scope without departing from the subject matter of the present invention.

The term “configured” is used to describe a component, section or part of a device includes hardware and/or software that is constructed and/or programmed to carry out the desired function.

The embodiments of methods, software, firmware or codes described above may be implemented by instructions or codes stored on a machine-accessible or machine readable medium. The instructions or codes are executable by a processing element or processing unit. The machine-accessible/readable medium may include, but is not limited to, any mechanisms that provide, store and/or transmit information in a form readable by a machine, such as a computer or electronic system. In some cases, the machine-accessible/readable medium may include, but is not limited to, random-access memories (RAMs), such as static RAM (SRAM) or dynamic RAM (DRAM), read-only memory (ROM), magnetic or optical storage medium and flash memory devices. In other cases, the machine-accessible/readable medium may include, but is not limited to, any mechanism that receives, copies, stores, transmits, or otherwise manipulates electrical, optical, acoustical or other form of propagated signals such as carrier waves, infrared signals, digital signals, including the embodiments of methods, software, firmware or code set forth above.

Furthermore, the particular features, structures, or characteristics may be combined in any suitable manner in one or more embodiments.

It is apparent that the present invention is not limited to the above embodiments, but may be modified and changed without departing from the scope and spirit of the invention.

What is claimed is:

1. An apparatus for controlling work process, the apparatus comprising:
a priority calculation unit that calculates a respective priority for each of devices available for process and for each of lots-in-process, with reference to at least first, second, third and fourth sets of information,
the first set of information comprising a respective number of lots-in-process for each of devices available for processing the lots-in-process,
the second set of information comprising a respective number of devices available for processing each of the lots-in-process,
the third set of information comprising a respective standard work time for each of the devices available for processing the lots-in-process and for each of the lots-in-process, and
the fourth set of information comprising a respective maximum possible working rate for each of the devices available for processing the lots-in-process; and
an allocation decision unit that decides a respective one of the devices, to which each of the lots-in-process is to be allocated, with reference to the respective priorities.

2. The apparatus according to claim 1, wherein the priority calculation unit calculates the respective priorities based on the respective numbers of lots-in-process, the respective numbers of devices available, the respective standard work times, and the respective maximum possible working rates.

3. The apparatus according to claim 2, wherein the priority calculation unit calculates each of the priorities by multiplying:
the reciprocal of the respective number of lots-in-process for each of devices available for processing the lots-in-process;
the reciprocal of the respective number of devices available for processing each of the lots-in-process;
the reciprocal of the respective standard work time for each of the devices available for processing the lots-in-process and for each of the lots-in-process; and
the respective maximum possible working rate for each of the devices available for processing the lots-in-process.

4. The apparatus according to claim 1, wherein the allocation decision unit selects a respective one of the devices for each of the lots-in-process so that the respective one has a maximum priority in the each lot-in-process.

5. The apparatus according to claim 1, wherein the allocation decision unit extracts respective combinations of the lots-in-process and the respective ones of the devices, to which the lots-in-process are to be allocated respectively, and the allocation decision unit selects one-by-one the respective combinations in the order of priority.

6. The apparatus according to claim 1, further comprising:
a priority calculation information acquisition unit that calculates:
the respective number of lots-in-process for each of devices available for processing the lots-in-process,
the respective number of devices available for processing each of the lots-in-process,
the respective standard work time for each of the devices available for processing the lots-in-process and for each of the lots-in-process, and
the respective maximum possible working rate for each of the devices available for processing the lots-in-process.

7. The apparatus according to claim 6, further comprising:
a priority temporary-allocation unit that executes temporary allocation for priority-processing of a lot-in-process according to a rule, the lot-in-process being a lot that is being in a waiting state,
wherein the priority calculation information acquisition unit receives a result of execution of the temporary allocation from the priority temporary-allocation unit.

8. The apparatus according to claim 7, further comprising:
an empty device determination unit that receives the result of execution of the temporary allocation from the priority temporary-allocation unit,
the empty device determination unit managing operating states of the devices,
the empty device determination unit determining, whether each of the devices is in working state or in empty state, based on an operating state of each of the devices and on the result of execution of the temporary allocation,
the empty device determination unit notifying, to the priority temporary-allocation unit, a result of determination of whether each of the devices is in working state or in empty state.

9. An apparatus for controlling work process, the apparatus comprising:
a lot allocation unit that gives a highest priority for lot-allocation to a device available for process, the device given the highest priority having at least one of a minimum number of lots-in-process and a maximum number of unworkable processes among devices available for process.

10. The apparatus according to claim 9, wherein the lot allocation unit comprises:
a priority calculation unit that calculates a respective priority for each of devices available for process and for each of lots-in-process, with reference to at least first, second, third and fourth sets of information,
the first set of information comprising a respective number of lots-in-process for each of devices available for processing the lots-in-process,
the second set of information comprising a respective number of devices available for processing each of the lots-in-process,
the third set of information comprising a respective standard work time for each of the devices available for processing the lots-in-process and for each of the lots-in-process, and
the fourth set of information comprising a respective maximum possible working rate for each of the devices available for processing the lots-in-process.

11. The apparatus according to claim 10, wherein the priority calculation unit calculates the respective priorities based on the respective numbers of lots-in-process, the respective numbers of devices available, the respective standard work times, and the respective maximum possible working rates.

12. The apparatus according to claim 11, wherein the priority calculation unit calculates each of the priorities by multiplying:
the reciprocal of the respective number of lots-in-process for each of devices available for processing the lots-in-process;
the reciprocal of the respective number of devices available for processing each of the lots-in-process;
the reciprocal of the respective standard work time for each of the devices available for processing the lots-in-process and for each of the lots-in-process; and
the respective maximum possible working rate for each of the devices available for processing the lots-in-process.

13. The apparatus according to claim 10, wherein the lot allocation unit further comprises:
an allocation decision unit that decides a respective one of the devices, to which each of the lots-in-process is to be allocated, with reference to the respective priorities.

14. The apparatus according to claim 13, wherein the allocation decision unit selects a respective one of the devices for each of the lots-in-process so that the respective one has a maximum priority in the each lot-in-process.

15. The apparatus according to claim 13, wherein the allocation decision unit extracts respective combinations of the lots-in-process and the respective ones of the devices, to which the lots-in-process are to be allocated respectively, and the allocation decision unit selects one-by-one the respective combinations in the order of priority

16. The apparatus according to claim 10, further comprising:
a priority calculation information acquisition unit that calculates:
the respective number of lots-in-process for each of devices available for processing the lots-in-process,
the respective number of devices available for processing each of the lots-in-process,
the respective standard work time for each of the devices available for processing the lots-in-process and for each of the lots-in-process, and
the respective maximum possible working rate for each of the devices available for processing the lots-in-process.

17. The apparatus according to claim 16, further comprising:
a priority temporary-allocation unit that executes temporary allocation for priority-processing of a lot-in-process according to a rule, the lot-in-process being a lot that is being in a waiting state,
wherein the priority calculation information acquisition unit receives a result of execution of the temporary allocation from the priority temporary-allocation unit.

18. The apparatus according to claim 17, further comprising:
an empty device determination unit that receives the result of execution of the temporary allocation from the priority temporary-allocation unit,
the empty device determination unit managing operating states of the devices,
the empty device determination unit determining, whether each of the devices is in working state or in empty state, based on an operating state of each of the devices and on the result of execution of the temporary allocation,
the empty device determination unit notifying, to the priority temporary-allocation unit, a result of determination of whether each of the devices is in working state or in empty state.

19. An apparatus for controlling work process, the apparatus comprising:
a lot allocation unit that determines a respective device, to which each of selected lots is to be allocated, the selected lots being lots on which actual working is currently required, the lot allocation unit determining the respective device with reference to at least a number of devices available for processing the selected lots and a number of the selected lots.

20. The apparatus according to claim 19, wherein the lot allocation unit determines the respective device by multiplying:
the reciprocal of a respective number of lots in the selected lots for each of devices available for processing the selected lots;
the reciprocal of a respective number of devices available for processing each of the selected lots;
the reciprocal of a respective standard work time for each of the devices available for processing the selected lots and for each of the selected lots; and
a respective maximum possible working rate for each of the devices available for processing the selected lots.
